(19) United States
(12) Patent Application Publication
(10) Pub. No.: US 2019/0162826 A1
(43) Pub. Date: May 30, 2019

(54) DISTANCE SENSOR

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-CHUN SUN, New Taipei (TW); ZHAN-SHENG LU, Shenzhen (CN); ZE-MIN WU, Shenzhen (CN)

(21) Appl. No.: 15/889,334

(22) Filed: Feb. 6, 2018

(30) Foreign Application Priority Data
Nov. 24, 2017 (CN) 201711194380.7

(51) Int. Cl. G01S 7/481; G01S 17/08

(52) U.S. Cl. CPC G01S 7/4813; G01S 7/4816; G01S 7/4814; G01S 17/08

(57) ABSTRACT

A distance sensor includes an IR emitter, an IR receiver, and an annular support. The IR emitter includes a transmitter. The IR receiver includes a number of transceivers. The annular support includes a transmitter support and a transceiver support. The transmitter support is located centrally within the transceiver support. The transmitter is arranged on the transmitter support. The transmitter emits infrared signals through a top of the annular support to a transmission lens, and the transmission lens scatters the infrared light. The transceivers are arranged on the transceiver support and positioned around a periphery of the annular support to receive reflected infrared signals.

### CROSS-REFERENCE TO RELATED APPLICATIONS

This application claims priority to Chinese Patent Application No. 201711194380.7 filed on Nov. 24, 2017, the contents of which are incorporated by reference herein.

### FIELD

The subject matter herein generally relates to a distance sensor.

### BACKGROUND

Generally, a distance sensor requires an emitter and a receiver. The emitter generally emits infrared signals, and the receiver is arranged on an object to receive the infrared signals. A distance between the emitter and the object can be determined based on the received infrared signals. However, providing the receiver on the object may increase a cost of the distance sensor.

### BRIEF DESCRIPTION OF THE DRAWINGS

Implementations of the present disclosure will now be described, by way of example only, with reference to the attached figures.

FIG. 1 is an exploded, isometric view of an exemplary embodiment of a distance sensor in accordance with an embodiment of the present disclosure.

FIG. 2 is an assembled, isometric view of the distance sensor in FIG. 1.

FIG. 3 is a cross-sectional view of the distance sensor.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

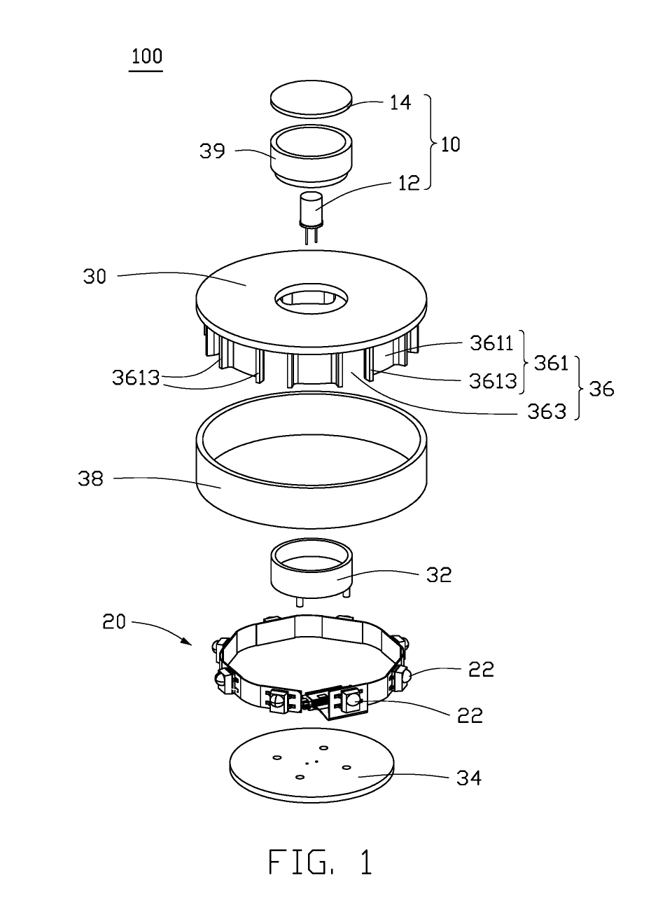

FIG. 1 illustrates an embodiment of the present disclosure. A distance sensor 100 includes an infrared (IR) emitter 10, an infrared (IR) receiver 20, and an annular support 30. The IR emitter 10 includes a transmitter 12, and the IR receiver 20 includes a plurality of transceivers 22. The annular support includes a transmitter support 32 and a transceiver support 34 therein. The transmitter support 32 is located centrally within the transceiver support 34. The transmitter 12 is arranged on the transmitter support 32 and transmits infrared signals through a top of the annular support 30 to a transmission lens 14. The transmission lens 14 scatters the infrared signals. The transceivers 22 are arranged on the transceiver support 34 and positioned at a periphery of the annular support 30 to receive reflected infrared signals.

When the emitted infrared signals are reflected by an object, the reflected infrared signals are received by the transceivers 22. A location of the object is determined by determining which of the transceivers 22 receive the reflected infrared signals, and a distance of the object is determined by a strength of the received infrared signals. The determination of the location and distance of the object based on the received infrared signals can be carried out by a processor (not shown). The transceiver support 34 is substantially round and disk-shaped. The transmitter support 32 is substantially ring-shaped and arranged centrally on the transceiver support 34. The transmitter 12 is arranged within the transmitter support 32 and is opposite to the transmission lens 14 arranged at a top of the annular support 30. The transmission lens 14 is a transparent parabolic mirrored optical lens to reflect and disperse the infrared signals. The plurality of transceivers 22 are arranged equidistantly around a periphery of the transceiver support 34. Each transceiver 22 can receive infrared signals within a defined angle. The magnitude of the angle is inversely proportional to the number of the transceivers 22. As the magnitude of the angle decreases, the number of the transceivers 22 increases, and vice versa. When there are more transceivers 22, the accuracy of detecting the object increases, but the cost also increases. In at least one embodiment, there are eight transceivers 22 spaced equidistantly around the transceiver support 34. The transceivers 22 can receives infrared signals within 360 degrees, and the angle of each transmitter 22 receiving infrared signals is 45 degrees. The transmitters 22 receiving the infrared signals are used to determine the location of the object.

The annular support 30 includes an annular grid 36 at a bottom of the annular support 30. The plurality of transceivers 22 are received within the annular grid 36. Specifically, the annular grid 36 includes a plurality of flaps 361 equally spaced apart around the bottom of the annular support 30. A gap 363 is defined between adjacent flaps 361. Each transceiver 22 is received within a corresponding gap 363, such that each transceiver 22 can receive infrared signals from different directions within the gap 363. The flap 361 includes two flanges 3613 and a groove 3611 defined between the two flanges 3613. The groove 3611 is defined in an outer surface of the flap 361. Each flange 3613 of the flap 361 faces a flange 3613 of an adjacent flap 361 such that the transceivers 22 receive infrared signals from a defined direction. The transceivers 22 received in the corresponding gaps 363 can receive infrared signals from the defined directions to accurately determine the distance and direction of the object.

The distance sensor 30 further includes a first transparent lens 38 arranged around a periphery of the bottom of the annular support 30. The first transparent lens 38 surrounds the transceivers 22. The first transparent lens 38 is substantially ring-shaped. The transmitter support 32 and the transceiver support 34 are received between the transparent lens 38 and the annular support 30. The first transparent lens 38 protects the plurality of transceivers 22 and does not influence reception of infrared signals.

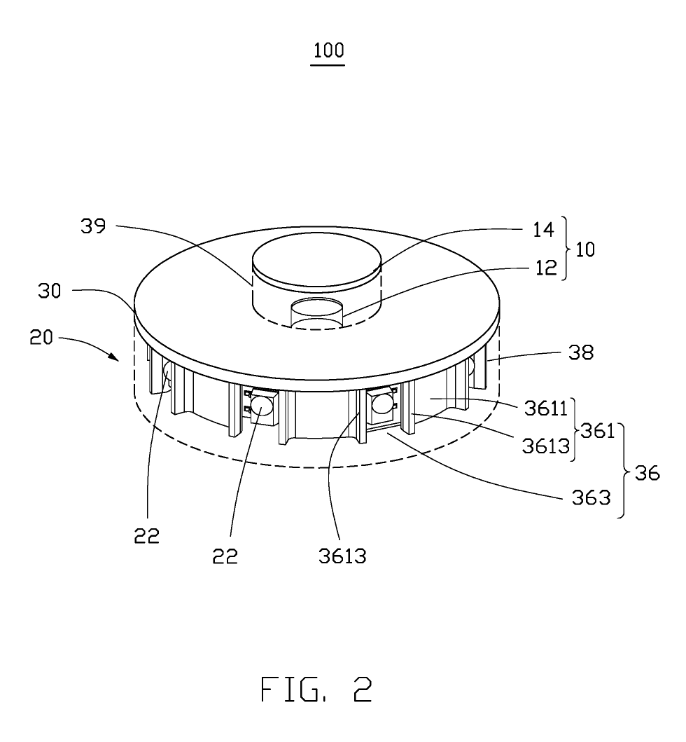

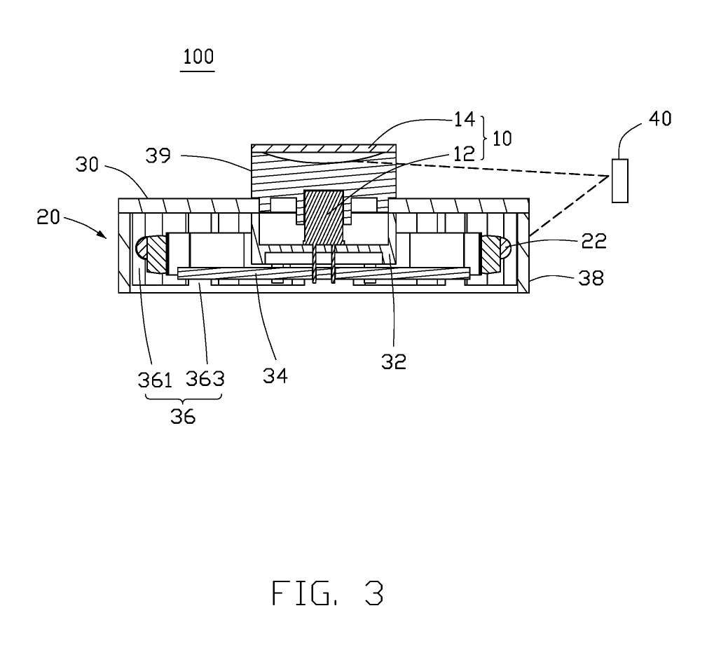

Referring to FIG. 2 and FIG. 3, the first transparent lens 38 (shown with dashed lines in FIG. 2) can protect the plurality of transceivers 22 and does not influence reception of infrared signals. The transmission lens 14 at the top of the annular support 30 is opposite to the transmitter 12. A second transparent lens 39 (shown in FIG. 2 with dashed lines) surrounds a periphery between the transmission lens 14 and the transmitter 12. The second transparent lens 39 can protect the transmission lens 14 and the transmitter 12 and does not influence emission of the infrared signals. The transmitter 12 emits infrared signals to the transmission lens 14, and the transmission lens 14 reflects and scatters the infrared signals. Thus, a detection range of the distance sensor 100 is enhanced. When the emitted infrared signals reach an object 40, the infrared signals are reflected and received by the transceivers 22, and the location of the object 40 can be determined by the processor according to the direction and strength of the reflected infrared signals. Thus, only one transmitter 12 is required to emit infrared signals in all directions, thereby reducing a cost of the distance sensor 100. If cost is not a concern, the object 40 can include a transceiver to accurately determine the location of the object 40.

The distance sensor 100 utilizes one transmission lens 14 to reflect and scatter the infrared signals, and the plurality of transceivers 22 can receive the reflected infrared signals from all directions.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A distance sensor comprising:
an IR emitter comprising a transmitter;
an IR receiver comprising a plurality of transceivers;
an annular support comprising:
a transmitter support wherein the transmitter is arranged on the transmitter support; and
a transceiver support wherein the transceivers are arranged on the transceiver support;
wherein the transmitter support is located centrally within the transceiver support;
wherein the transmitter emits infrared signals through a top of the annular support to a transmission lens; and
wherein the transceiver support is positioned around a periphery of the annular support to receive reflected infrared signals.

2. The distance sensor of claim 1, wherein the transmission lens is opposite to the transmitter; and the infrared signals are reflected by the transmission lens and scattered.

3. The distance sensor of claim 1, wherein the transmission lens is a transparent parabolic mirrored optical lens.

4. The distance sensor of claim 1, wherein the plurality of transceivers are arranged equidistantly around a periphery of the transceiver support.

5. The distance sensor of claim 4, wherein the plurality of transceivers receive infrared signals within a defined angle.

6. The distance sensor of claim 1, wherein the annular support comprises an annular grid arranged on a bottom of the annular support; the plurality of transceivers are arranged within the annular grid.

7. The distance sensor of claim 6, wherein the annular grid comprises a plurality of flaps spaced equidistantly from each other around a bottom of the annular support; a gap is defined between adjacent flaps.

8. The distance sensor of claim 7, wherein the annular grid is opposite to the plurality of transceivers, and the plurality of transceivers are received within the gaps defined in the annular grid; the transceivers received the infrared signals through the gaps.

9. The distance sensor of claim 8, wherein each flap comprises two flanges and a groove between the two flanges; the groove is defined in an outer side of the flap; each flange of the flap faces a flange of an adjacent flap such that the transceivers receive infrared signals within a defined direction.

10. The distance sensor of claim 1, wherein the annular support comprises a transparent lens arranged around a bottom periphery of the annular support and surrounding the plurality of transceivers.

11. The distance sensor of claim 10, wherein the transmitter support and the transceiver support are received between the transparent lens and the annular support
